(19) United States
(12) Patent Application Publication
(10) Pub. No.: US 2003/0064767 A1
(43) Pub. Date: Apr. 3, 2003

(54) Computer controlled card game

(76) Inventor: Grant E. Brown, No. Myrtle Beach, SC (US)

Correspondence Address: Michael E. Mauney, Attorney at Law, Post Office Box 10266, Southport, NC, 28461, US

(21) Appl. No.: 09/970,410

(22) Filed: Oct. 2, 2001

(51) Int. Cl. A63F 13/00

(52) U.S. Cl. 463/12; 463/13; 463/25; 273/274; 273/292

(57) ABSTRACT

An apparatus and method for playing card games using a computer so that cards are printed and discarded each time a game is played. Two or more players play a card game against each other in the normal way a game would be played by using a deck of cards. However, here a computer manages the deal of the cards and display of hand by printing down cards for distribution to a player station and by displaying up cards on a common video monitor. At the conclusion of a hand, the computer determines the winners and makes calculations to determine each player's winning and losing for that particular game and cumulative to that point in the play of a series of games. A new game is begun and the old printed down cards are discarded.

### FIELD OF THE INVENTION

This invention relates generally to an apparatus and method for playing card games generally and Poker specifically using a computer. More specifically, this allows two or more players to play a card game against each other in the normal way the game would be played by the use of a deck of cards. However, here the computer deals the cards either by displaying cards on a video monitor or by printing cards distributed to each player's playing station at the computer game. The winning hand is determined using the rules of the game, for example like the traditional ranking of Poker hands, but the computer does the calculations of determining a winner or loser. Card games similar to Poker like Blackjack can be played using this invention.

### BACKGROUND OF THE INVENTION

Perhaps the best known card game in which gambling is an integral part of the game is Poker. The rules of Poker have largely fixed for more than a century and almost everyone has played Poker at some point in their lives, if only for penny wagers or chips. In a traditionally played Poker game, one of the players shuffles and deals from a standard deck of 52 playing cards. Occasionally, Jokers are added to the deck in some variations of the game so that a Joker may serve as a “wild” card. The game proceeds according to the rules of the game with the winner being determined according to the rank of Poker hands. Poker hands are ranked from the highest to the lowest depending on the odds of obtaining a particular hand. The higher the odds are of obtaining a particular hand, the higher the rank that hand has in determining the winner of the game. Thus, the rarest hand of all, an Ace-high straight flush (commonly called a “Royal Flush”), is the highest hand possible in any game with no wild card. The game proceeds according to the rules with one or more wagers being made usually after cards are distributed by the dealer. Once all the cards have been distributed and the wagering is complete, down cards are revealed with the winner being determined.

Broadly speaking, Poker games are split into two types. First, is where all cards are down and a player usually has the option of discarding some cards and receiving other cards from the dealer. This is typically called “draw Poker” representing the “draw” of new cards following a discard of unwanted cards. The other variation is where some cards are up and in view of all players. This is called “stud”. There are many variations of stud Poker, including five-card stud, seven-card stud, and various games where cards are dealt up and are held in common by all participants in the game. Games such as “Spit-in-the-Ocean” or “Texas Hold ‘Em” are variations of this kind of stud Poker.

There have been many attempts to introduce Poker into a casino or game room environment. There are very popular games that are, at least in some sense, based on Poker. There are a variety of video Poker games where one apparently plays “draw” Poker in an attempt to build a hand. The video Poker machine pays off according to a preset schedule of odds so that winning hands may receive more than the amount bet by the player. However, these games, while resembling Poker, have nothing to do with the actual play of a Poker game. In fact, they are little more than a slot machine with a preset, pre-determined house winning percentage. These Video Poker games have little of the interest or strategy involved in a real Poker game. In a traditional Poker game, the players play against each other and not against the house. Consequently, in the traditional Poker game, there is no preset or assured house percentage, unlike Roulette, Blackjack, or other common types of casino games.

Some casinos or game rooms nevertheless allow Poker to take place on their premises. Typically, a player pays a certain percentage of the pot as the house cut. Sometimes the player may pay a certain amount per hour as a form of rental for use of the premises. Typically, the house will provide a dealer who both shuffles and deals the cards and also collects money from the players for the house charge or cut. This type of service has proved unpopular in casinos for a variety of reasons. First, it is expensive to provide the Poker tables with a dealer. If one has ten Poker tables available and only a few people are playing Poker, then nine dealers must stand by while nothing is occupying their attention. They must be paid an hourly wage making it difficult for the house to make a profit Ideally, the house should be able to supply a dealer only as required. However, this would mean having personnel available from other parts of the casino to come to the Poker room should play prove unexpectedly heavy. This creates personnel problems for a casino or Poker house.

Another reason Poker games have proven difficult to implement is because of the possibility, indeed the likelihood, of player misconduct. Where the players themselves deal the cards, there is always a risk that a particular player may be a card cheat who marks the cards or who stacks the deck in order to better his or her odds in prevailing in the game. In a circumstance where individuals play with strangers, this is a particular problem. It is for this reason that few casinos will allow players the opportunity to deal the cards themselves. Even where a house dealer is dealing the cards, there is still a risk a player may mark the cards in some way, may palm or hide cards that he can use to cheat, can steal chips from the pot, or can enter into an alliance with an unscrupulous house dealer to rig the game in the favor of a particular player. Obviously, players who feel they have been cheated can cause problems for a casino in which the alleged cheating took place. Because of the low profit involved for the house and because of the likelihood of disruption and/or cheating episodes, few gambling casinos encourage players to use their facilities for Poker.

A variety of attempts have been made to deal with this problem. One way of dealing with this problem is to simply provide a simulation of a Poker game through a video display, such as the so-called Video Poker games. These games have little interest to a real Poker player. Additionally, there are other types of variations of Poker games, which can be played in casino settings. Two such games go by the trade names of “Caribbean Stud” and “Let It Ride”. These games are sometimes played on tables and/or played on video machines. Again, these games are not real Poker games but are simply games that use, in some ways, the rankings of a Poker hand to allow a person to play against the house.

Various home computer games allow one to play Poker against the play of other imaginary computer controlled players. These games are widely sold where other types of video games are sold. While this allows one to play with the rules of Poker and in a randomly dealt deck, it lacks the true challenge of playing against other people since the strategy employed by the computer to play the other hands is necessarily limited. Moreover, these games usually do not allow real wagering. Sidley, U.S. Pat. No. 4,760,527, discloses an electronic system for playing Poker. This system has a central processing unit and a plurality of individual player consoles, each having a display device and an input device. The display shows each player his own hand, as well as the “up” cards of other players. The input device allows a player to respond to game conditions, to make wagers, and so on. This avoids some of the problems inherent in a traditional Poker game, but adds problems of its own. Here, a plurality of individual video displays are required. The space and the amount of money required for such individual displays is prohibitive in many applications. Moreover, most Poker players are quite careful to hide the view of their cards, not only from other players but from onlookers, for fear that someone could give away their hand. For this reason, hole cards are traditionally kept face down on the table with the player very carefully looking at the cards and guarding them so that only that player will know what his or her hole cards happen to be. This is difficult to achieve in a circumstance where there are video displays that a player looks at. Moreover, many players like the tactile sensation of having cards. Many Poker players will traditionally shuffle their hole cards as the game proceeds. Sometimes players may pass their hole to an onlooker or someone else who may carefully view them and then return them to the player. Lamle, U.S. Pat. No. 5,199,710, discloses a way of printing playing cards for use during the course of the game. The Lamle patent is designed to avoid problems particularly found in Blackjack games where “card counters” can affect the house percentage by keeping careful records of what cards have been dealt and used during the course of the play of the game. Casinos have dealt with this problem by providing multiple decks of cards, frequent shuffling, prohibiting card counters from playing when identified, and other expedients. The Lamle patent is designed to avoid this by making each play of the game printed from a unique randomly shuffled deck of cards which are printed afresh and used only once. Hence, the card counter's advantage over the house is reduced.

### SUMMARY OF THE INVENTION

Despite this earlier work there is still no satisfactory apparatus and method for playing Poker, which can be adopted to a casino or game room environment that avoids all the aforementioned problems of cheating, card stacking, card marking, “short pots”, and so on. The current invention consists of a central processing unit and one large central video display. At spaced intervals around the video display are individual player seats. Disposed at each player seat, usually seven in number, there is an input device whereby the player can interact with the computer to signal the player's intentions in the game, whether to receive further cards, to make bets, to raise bets, to fold, and so on. Also at each player place is a slot. Within the playing table at each player seat is a card printer with sufficient memory to retain images of cards for immediate printing by appropriate means which are “dealt” to a player at the slot. There are start-up controls where players may choose how the game will be played. This will ordinarily involve such things as determining the variation of the game to be played, the amount of permissible wagers, the terms and limits for wagers, the number of players, and so on. Once the terms of the game have been set the game will proceed. At each seat, a player will receive cards printed specifically for that individual play of one game, printed by the printer at each player's seat at the table. So, for example, if the game is seven-card stud, each player will receive two cards printed and delivered to the slot at his place on the table by the printer located within the game at that player's seat. Then one “up” card will be displayed for each player on the large commonly viewed video display. The game will proceed in the usual fashion with the machine controlling the play of the game. The machine will determine who has the first wager, will keep track of the wagers made, the response of the each player to the wagers, and so on. This avoids issues of players claiming they have called a wager when they have not, claiming they raised when they did not, of the pot being “short”, and so on. The game will proceed until its conclusion. If all players stay in until the end, then each player in a seven-card-stud game will have four up cards displayed on the video display, the two original printed hole cards and the final printed hole card dealt to the player by the printer just before the last round of betting. Once the last round of betting is accomplished, the game is over. The machine then displays all of the cards of the player on the video display, declares the winner, and adjusts the player's credit on the machine accordingly. The machine will keep automatic track of who is ahead and by how much. The printed cards which have just been used in that particular hand will be discarded. It is impossible for a player to cheat in this game. Even should the player have a hold pack of Aces in his pocket, he cannot substitute them for the cards given to him by the computer because the computer determines who wins and loses the game and displays the cards for all hands at the end of the game. A player cannot mark the cards because they are not recycled in the game. A player cannot claim to have made a wager when he did not make a wager nor can there be any collusion between players in which cards are exchanged. Thus, most of the common ways that players attempt to cheat are impossible in this game. Moreover, the computer, of course, cannot be corrupted and made part of a cheating scheme, which unfortunately cannot be said for human dealers. There is no need to pay anyone to be at a table when it is not in use. As soon as enough players are available to make use of the game, the game is ready to proceed. As with other video games, the house may simply charge a fee for the use for each hand. Just as someone may pay fifty cents to pay a video game like Pac-Man®, each player might pay a quarter or fifty cents to play a hand of Poker. Alternately, a certain set amount could be charged for a preset number of hands or a per hour charge could be made for use of the table.

This machine could be used in many venues where Video Poker machines are not allowed. The house itself is not making any wagers, taking any house percentage, or doing any other of the actions which are ordinarily considered indicative of gambling machines. Rather, the house is simply making the machine available for use by the players. The players may or may not pay off bets at the end of the game. When a round of play is over, the machine prints out for each player the results of the game showing if a player has won or lost and, if so, how much. This game allows two or more people to play Poker in a convenient setting in a restaurant, bar, grill, game room, or the like. It may be for fun, it may be for pennies, or it may be for high stakes. Each player can be assured that the play of the game is being fairly administered by the computer and that there is no such thing as a card shark, stacked decks, marked decks, short pots, or the other problems that plague Poker games in game room or casino settings where players may be strangers. It can be used in home setting or as a bar game. It allows a player to use their skill in Poker in knowing when to draw, when to stay in the game, when to bluff, and when a hand is likely to win or lose. As with any Poker game, the more skillful player is more likely to win in the long run, but the same amount of randomness that affects a fairly played Poker game will affect the outcome of this game.

### BRIEF DESCRIPTION OF THE DRAWINGS

FIG. 1 is a view from above of a table comprising the current invention.

FIG. 2 is a cut-a-way of the table of the current invention.

FIG. 2A is a cut-a-way showing a players station of the current invention.

FIG. 3A is a simplified flow chart showing how money is received for play of the game.

FIG. 3B is a simplified flow chart showing how the game proceeds.

### DETAILED DESCRIPTION OF THE DRAWINGS

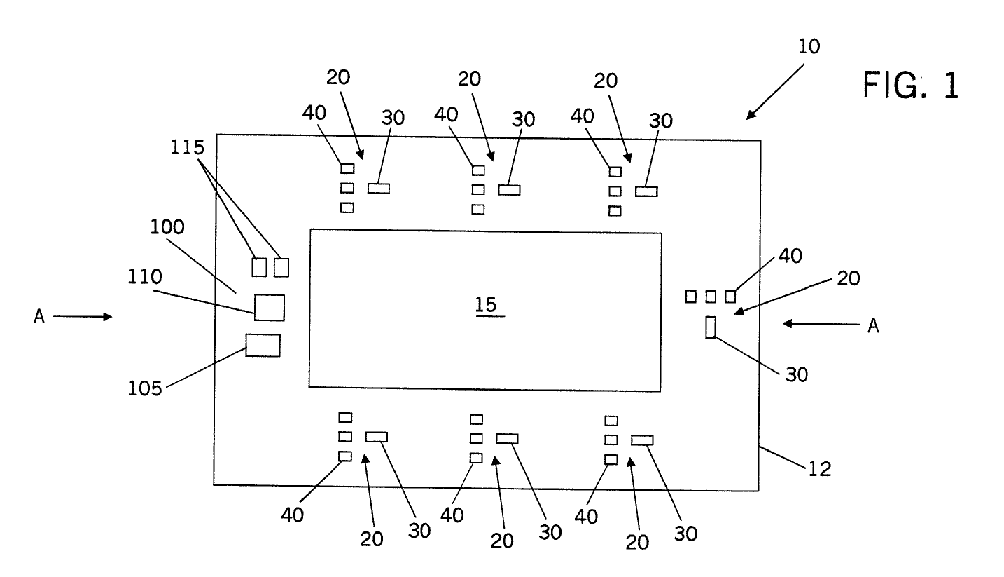

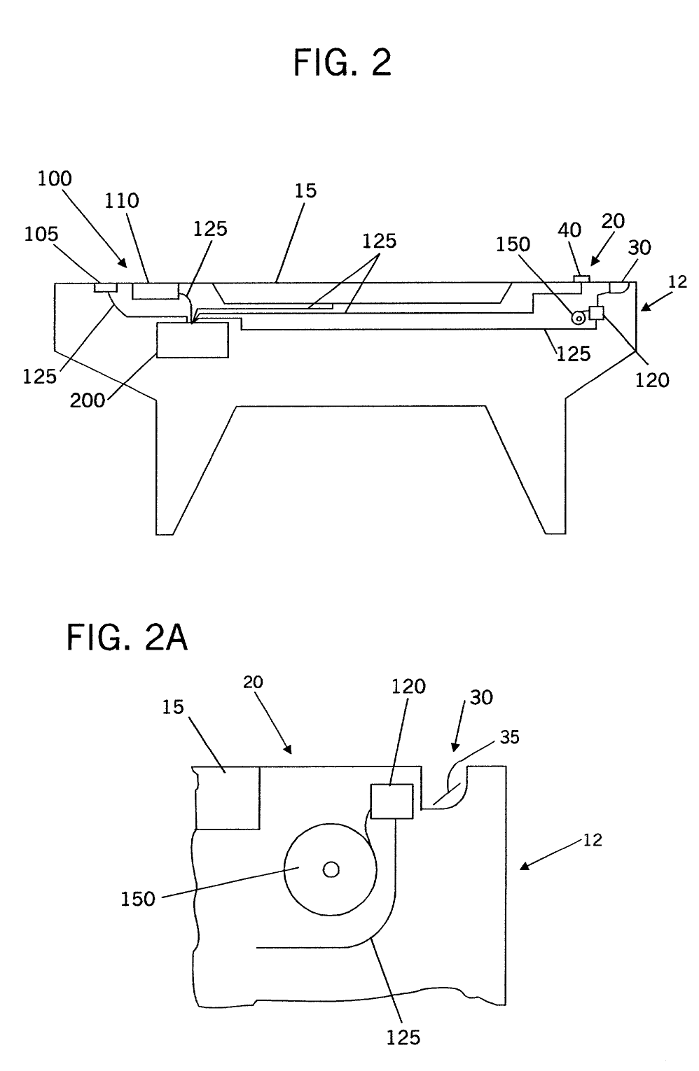

FIG. 1 shows the current computer controlled card game (10) table (12) seen from above. There are seven player stations (20) and one game control station (100). Each player station (20) has a card dealing slot (30) and player control buttons (40). In the center of the table (12) is a large common video display (15). The game control station (100) consists of a money input (105), a control device (110), usually a touch screen, and input buttons (115). The computer controlled Poker game (10) will necessarily have a programmable central processing unit (CPU) (200) ordinarily positioned below the game control station (100). The CPU (200) is not seen in this figure but is shown in FIG. 2, but will be connected to the money input (105), the control device (110), and the input buttons (115) and to each player station (20).

In a game room environment, the computer controlled card game (10) will ordinarily be on and operating in an automatic mode, in part, to attract players. Once people have decided they want to play, they will approach the machine and use the control device (110) according to printed instructions which may be present on the table. The CPU will display appropriate instructions on the video screen (15) or on the control device (110) in a way to be viewed readily by a player standing at the control station (100). The instructions might read: “Please insert money to begin game.” For example, a player might insert ten dollars into the money input (105) to play ten games. Once the money is inserted to play, the video display (15) or control device (110) will display further instructions to a potential player to complete the game. A player might choose a game, typically seven-card-stud, five-card-stud, or seven-card-high/low-stud. The player could continue to make appropriate choices using the control device (110) and input buttons (115) to pick particular variations until ready to begin.

As an example, assume there are two players who wish to play one game of five-card-stud. The rules will be for a dollar ante with a five dollar limit The player may appropriate choices using the control device (110) and input button (115) then begin the game. Two player stations would be activated. One hole card would be printed and ejected through the slot (30) and one up card would be displayed on the video display (15) for each player station activated. The computer would determine which player had the highest up card, who, according to the rules of Poker, would initiate betting using the control buttons (40). The other player would respond using the control buttons (40) to call, raise, or fold. The game would proceed to a conclusion, with one player winning and one player losing. The computer would calculate the winnings of the victorious player and through the card slot (30) print a result Players could then pay-off or not, depending on whether they were playing for real money or for fun.

FIG. 2 is a cut-a-way view of the poker game table (12) seen from the side along lines A-A in FIG. 1. At one end of the table is the money input (105), a control device (110), usually a touch screen, which comprise the game control station (100). The money input (105) and the control device (110) are connected by cables (125) to the CPU (200). In this view, the input buttons (115) are not shown but they are connected to the CPU (200) by cables (not shown). Other cables (125) connect the CPU (200) to the video display (15) and to each player station (20). In this view, only one of the seven player stations (20) is seen. Cables connect the player control buttons (40) to the CPU (200), as well as each printer (120) is connected to the CPU (200) by cables (125). Currently, a CPU (200) based on an Intel x86 computer chip works well. Software, among other softwares, that can be employed in the CPU (200) is Microsoft Windows “NT”. The CPU (200) will be equipped with a multi-port serial adapter to connect to the seven player stations (20), printers (120), the control device (110), the money input (105), and other peripherals that may be required. The video display (15) is preferably a large screen plasma display, which will ordinarily require a special video card inside the CPU (200).

FIG. 2A shows in more detail in cut-a-way a printer (120) beneath a player station (20) at the table (12). The printer (120) is positioned at or near the card dealing slot (30). It is connected by cables (125) to a CPU (200) (not shown) for control. In current technology, a large roll of thermal paper (150) is positioned to feed into the printer (120), which prints the images of the cards (35) on the thermal paper (150) fed into the printer (120) and ejects the printed images of the cards (35) into the player's slot (30). The CPU (200) (not shown) will tell the printer (120) what cards to print. For a printer (120), certain requirements must be present. The printer (120) must print the cards quickly enough so that no undo delay is experienced by the player in receiving his cards. A player is accustomed to the deal of the cards taking a few moments of time. Consequently, the players will be prepared to wait a few seconds to receive their cards, but will become impatient if the printer takes too long. Consequently, no more than a few seconds should be devoted to the printer for printing each card (35) and ejecting the cards into the slot (30). To that end, the printer (120) must have enough extra memory to store the images of all cards required—52 for a regular deck of cards, or with jokers, if jokers are to be provided as part of the game. The memory should be changeable so that the images of the cards can be changed. Typically, as the game is turned on and the CPU (200) boots up, it will either load images into the printer (120) or check the memory in each printer (120) to be sure the images of the cards are intact, so that no delay will be involved reloading images into the printer (120) at the time the play of a game begins. One printer (120) that has been found in practice to work well is the AXIOHM A-794 Thermal Printer. This model is equipped with extra flash memory. Approximately two megabytes is required to store images of cards. As printer technology develops, it may be possible to print cards on paper stock other than thermal paper and to print color images of cards. Using current technology, thermal paper can print red and black images, which is sufficient to indicate suits of the red diamonds and hearts and the black spades and clubs. It is anticipated in time that ink jet technology or laser technology may be used to print the card images, but in current technology a thermal printer has been found to work best and most practical for use in the game.

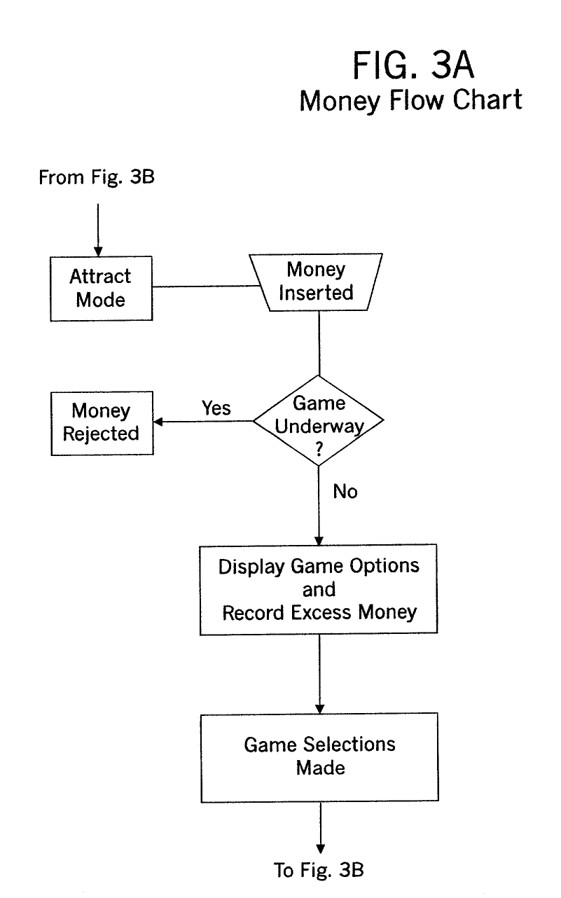

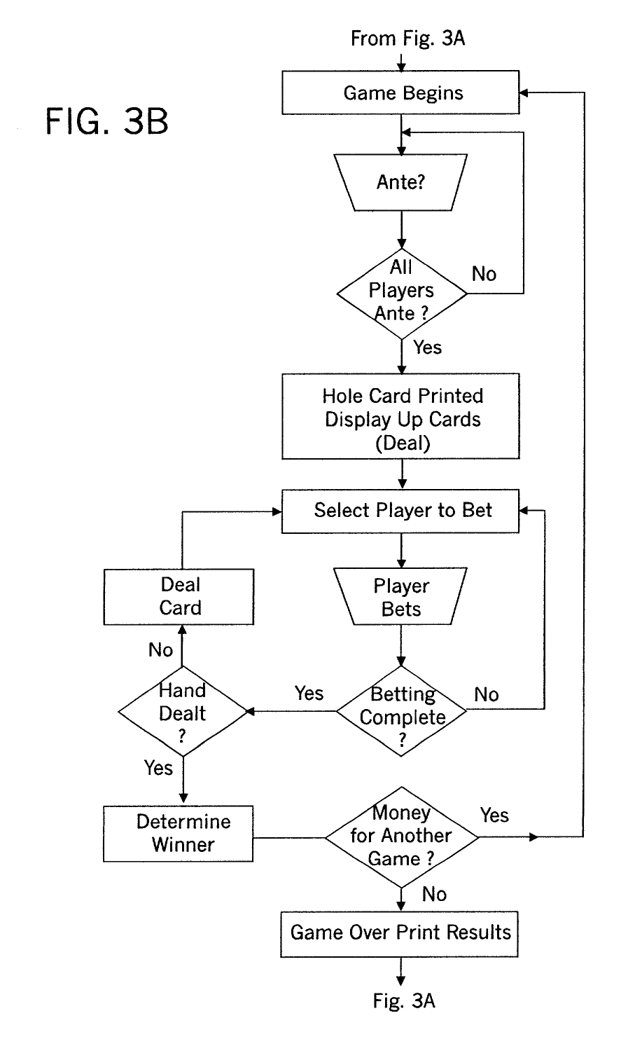

FIG. 3A shows a money reception simplified flow chart for the game. Ordinarily, the game would be in attract mode. This means it will be playing games, declaring winners, dealing cards, and the like so that someone could observe the game and get an idea how it is played. Once players decide to begin the game, they begin by inserting money into the money input (105). The CPU (200) is connected the money input (105). The CPU (200) will determine if a game is underway. If a game is underway, then the money is rejected and returned through the money input (105) to the potential players. If a game is not underway, then the control device (110) will display selections, usually on a touch screen, and record or bank the money inserted. If only money enough for one game is inserted, then it will be so noted. If more money than is required for one game is inserted, then the players will be given credit for other games. The players will then make selections using the control device (110) and input buttons. This will ordinarily consist of determining what kind of game to play, how many players are to play, what kind of bet limits will be allowed, and so on. These are the usual things that will be decided at a poker game before the deal of a hand. Once the selections have been made, the game will begin.

FIG. 3B is a simplified flow chart for a poker game. The players enter the game begin mode from the money flow chart seen in FIG. 3A. The game begins by a player anteing. The machine determines if all players have anteed. A player will ante by using the player control buttons (40). If all players have not anted, then the game will not begin until all players ante. Once all players have anted, cards are dealt. Depending on the game chosen by the players, the printer will print an appropriate number of hole cards—for example, one hole card (35) for five-card-stud or two hole cards (35) for seven-card-stud—and distribute them through the card dealing slot (30) to each player station (20), which has been activated as shown in the money flow chart in FIG. 3A. Appropriate numbers of up cards will be displayed, usually one in any kind of stud game. Typically, in a stud game, the player with the strongest hand showing on the table is the one who is required to bet first. The machine will select the player to make the first bet and notify the player appropriately by flashing his display, use of a programmable voice chip, or the like. The player will then be required to check, bet, or fold using the player control buttons (40). The machine will then determine if betting is complete. If the betting is not complete, then it will select the next player to call raise, fold, or check as the rules require. Once the betting is complete, then machine will determine if the hand is fully dealt. If, for example, four cards have been dealt in five-card-stud, then the next card would be dealt either by displaying it as an up card or by dealing a down card and then select the player to make the next bet Once the hand is fully dealt and all betting is complete, then the game determines a winner, displays all cards, both hole cards and up cards. At this point, the game will check to see if there is any money banked for further games. If the money is not exhausted, then a new game begins with the players anteing. If all money has been exhausted, then the machine will print and display the results at each player's station and return to the attract mode. If players desire to continue, they will have to insert more money to begin a new game.

It will be understood by one of skill in the art that the charts in FIGS. 3A and 3B are a highly simplified flow charts. Actual programming flow charts would have many sub-routines and would be much more detailed. For example in FIG. 3B, consider the box in the middle of the flow chart labeled “select, pay and bet”. Typically, in a draw poker game, the first player to bet is the one to the dealer's immediate left. However, the deal rotates in the game in a clockwise direction—that is, the player who deals the next game will be sitting to the dealer's immediate left The person who initiates betting and the order of betting in a limit poker game can be an important part of the strategy of the game. Therefore, any game program must follow typical rules for the game selected by the player. In a draw poker game where there are no up cards, the player sitting to the dealer's immediate left initiates the betting. In a stud poker game, the player with the best hand initiates the betting. Consequently, the player with the highest card showing as an up card will initiate the betting. After the next card is dealt the game program would again have to determine which poker hand is “best” for the up cards in a stud game. For example, the player with the first Ace would ordinarily initiate the betting in a stud game. However, after two cards are dealt the player with an Ace/King might not initiate the betting if someone else has a pair of cards, i.e. a pair of two's is considered a better hand than an Ace/King. Therefore, the player with the pair of two's showing would initiate the betting. For example, in FIG. 3A in the box labeled “game selection made”, a player would ordinarily choose a particular game. This would cause the CPU (200) to load that game program which would set up the appropriate algorithm to determine what player makes the first bet. It will be noticed in the game flow chart shown in FIG. 3B, there are several loops. First, there is a loop to determine if all players have anted. In most circumstances, this could be done automatically by the machine rather than waiting for a player's action. Secondly, there is a loop following the deal of any single card (or cards in draw poker) for a round of betting. This ordinarily involves a loop because a player has options about checking, calling, or raising. Whenever a player raises a bet, then every player who had previously either initiated or called the earlier bet must again decide if they wish to call or raise the new bet. Most limit poker games place an upper number on the amount of raises allowed in any one round of betting—three is a typical number allowed. For example, when the cards are dealt, the first player designated by the machine to bet may check, then the turn to bet may be checked around the table until the last player, who might choose to bet. The bet then goes around the table again to each player who may call, fold, or raise. If someone chooses to raise at that point (presuming the rules allow checking and raising), then, again, the betting could go around the table. There is a second loop where the machine must determine if the hand has been completely dealt. In seven-card-stud there would be an initial deal of three cards, two down cards (35) printed and distributed by the printer to the player stations (20) through the card dealing slot (30). One up card would be displayed on the video display (15). The fourth card for each hand is dealt as an up card and displayed on the video display (15). The fifth card is dealt as an up card and displayed on the video display (15). The sixth card is dealt and displayed on the video display (15). However, the seventh card (35) is a down card, hence, is printed by the card printer (120) and distributed to each player who is still active in the game at that point through the card dealing slot (30) at that player's player station (20). After the deal of the seventh card there is the last round of betting. When that round of betting is complete, the machine determines that the hand has been completely dealt and, at that point, determines the winner. All cards, down and up cards, will then be displayed on the table (12) in the video display (15) and the machine determines a winner and distributes the winnings. To determine the winner itself is a process that will require a flow chart of considerable complexity depending on the game involved. First, the machine must recognize appropriate poker hands, compare them to the predetermined rank of poker hands, then compare each hand on the table to the other player's hands and determine which has the best poker hand. In a high-low poker game common for seven-card-stud, there will be two winners, although the winner of both the high and the low pots might be the same player. The pot is split between the two players, appropriate calculations are made, money is subtracted from the players predetermined bank of money, and the machine begins another round of play. If there is no money available for another round of play - that is, if no money has been deposited in the money input (105)—the players may be queried if they wish to continue to play and, if so, they would need to deposit more money. If no more money is deposited, then the game will be over. Each player will have a final result printed and distributed through the card dealing slot. Therefore, it will be seen that at virtually every place on the flow chart in FIG. 3B represents a sub-routine or sub-flow chart for the actual programming instructions. However, programming for computer operated poker games are well known to one of skill in the art. It will be noted here that the machine itself does not pay off nor is it involved in decisions about the actual play of the game. Rather, the machine facilitates play among the players. When the results of the game are printed following the conclusion of a game or a round of games, one player might be a hundred credit units ahead while another player would be a hundred credit units behind. This means if the two players were actually playing for money, then the player who is ahead would expect to be paid by the player who is behind the corresponding amounts represented by the hundred credits—whether a penny, a dime, a dollar, or some other figure assigned by the player at the start of the game for the game credits. This is the way the game would be used in venues where gambling is not allowed. However, it could be readily appreciated that in venues where poker is allowed the machine could be easily modified to allow immediate pay offs. For example, at each player's slot there could be a separate slot for receipt of a credit or debit card or for the deposit of money. The players might be required to deposit a certain minimum amount to participate in the game—for example, $500 in a ten-dollar limit game. At the conclusion of the game, the machine could either return money to the players or print a credit slip to be redeemed at the casino pay out windows in the same way that chips are cashed in casinos.

It will be readily appreciated by one of skill in the art that card games other than Poker could be played utilizing the current invention. For example, players could play Blackjack with the house only providing the venue for players to play. Each player could serve as the dealer according to the rules of the game. For example, in Blackjack where there is no house dealer a player who wins a game with a natural “Blackjack” of an Ace and of a card with a point count of ten will win the deal and become the dealer playing against the other players. This player will remain the dealer until someone other than this player wins a game with a natural blackjack. There are other types of card games which may utilize a dealer or may use up and down cards. This machine can be readily adopted to those types of games. It will be understood by one of skill in the art that the foregoing explanation regarding a Poker game is a description of what is believed to be the most likely commercial use of the machine, but in no way is intended as a limitation upon the scope of the invention. Rather, that is accomplished solely by the Claims which follow.

I claim:

1. A computer controlled card game apparatus comprising:
(a) a central processing unit;
(b) a video display connected to staid central processing unit;
(c) at least one printer connected to said central processing unit;
(d) means for distributing materials printed by said printer to at least two players in a card game controlled by said computer controlled card game apparatus;
(e) player controlled means for inputting player's decision about play of a game to said central processing unit;
whereby said central processing unit uses rules of play of a particular game to manage play of a game between at least two players, said play of the game includes distribution of down cards printed by said printer to said players and display of up cards on said video display with said central processing unit receiving input from players through said player controlled means for inputting to manage play of game and with said central processing unit recording player's actions and distributing further cards until the play of a game is complete.

2. A computer controlled card game apparatus of claim 1 wherein said central processing unit is programmable with rules of play of different games whereby players may choose what game they wish to play at the point of initiation of play of a card game on said computer controlled card game apparatus.

3. A computer controlled card game apparatus of claim 2 further comprising a table housing said programmable central processing unit with said video display mounted in said table, with said printer mounted in said table, and with said table having at least two player stations, said player stations mounting said player controlled means for inputting player's decisions about play of the game.

4. A computer controlled card game apparatus of claim 3 wherein each player's station has a printer and a means for distributing materials with each printer connected to said central processing unit.

5. A computer controlled card game apparatus of claim 4 wherein said printer contains means for storing images of playing cards whereby said printer can print playing card images at least at approximately the same speed as a dealer can distribute cards.

6. A computer controlled card game apparatus of claim 5 whereby said programmable central processing unit is programmed with rules of play of a poker game requiring up cards and hole cards wherein said video display displays said up cards and said hole cards are printed by said printer and distributed to said player station by means for distributing.

7. A computer controlled card game apparatus of claim 6 wherein said cards printed by said printer and distributed to said player station are discarded at the conclusion of the play of each game whereby the possibility of a player retaining cards from play of poker games to cheat is obviated.

8. A method for playing a computer controlled card game comprising:
(a) providing a central processing unit;
(b) displaying cards on a video display controlled by said central processing unit;
(c) printing cards and distributing them to a player station by at least one printer controlled by said central processing unit;
(d) providing means for inputting directions from a player regarding play of a hand to said central processing unit;
whereby said central processing unit manages play of the game between at least two players using the rules for a particular game, sending signals to said video display to display cards, sending signals to said printer to print and distribute cards to players, receiving input from said player input means and managing play of a game until play of a game is complete;

9. A method for playing a computer controlled card game of claim 8 further comprises providing a programmable central processing unit whereby said central processing unit is programmable with rules of play for different card games so at the beginning of a particular game a player may input that particular game the player wishes to play to said programmable central processing unit at the point of initiation of the play of a card game.

10. A method for playing a computer controlled card game of claim 9 further comprises providing a table to house said programmable central processing unit, said video display, said printer, and said means for inputting player's decision about play of a game.

11. A method for playing a computer controlled card game of claim 10 wherein providing a table has a further step of providing at least two player stations at said table, said player station has said player controlled means and has a slot for receipt of cards distributed by said printer to said player station.

12. A computer controlled poker game table comprising:
(a) a table with a central video display;
(b) within said table a central processing unit connected to said video display;
(c) a plurality of player stations distributed around said table, each of said player stations having means for inputting a player's decision about the play of a poker game to the central processing unit and a slot for receipt of printed playing cards;
(d) at least one printer connected to said central processing unit for printing said playing cards and distributing them to each of said player stations;
whereby a poker game can be played by players seated around said table receiving down cards from said printer, with up cards displayed on said video screen in said table, with said central processing unit managing the play and determining the outcome of said poker game among said players.

13. A computer controlled poker game table of claim 12 wherein said central processing unit is programmable to play a variety of different variations of poker.

14. A computer controlled poker game table of claim 13 wherein for each player station of said plurality of player stations there is a printer connected to said central processing unit for printing playing cards and distributing them to players at said slot at each of said plurality of said player stations.

15. A computer controlled poker game table of claim 14 wherein each of said printers contains means for storing images of playing cards whereby said printer can print playing card images at least at approximately the same speed as a dealer can distribute cards.
